(19) United States
(12) Patent Application Publication
(10) Pub. No.: US 2015/0348095 A1
(43) Pub. Date: Dec. 3, 2015

(54) MEASURING ADVERTISING EFFECTIVENESS

(71) Applicant: NINTHDECIMAL, INC., San Francisco, CA (US)

(72) Inventors: Mark Dixon, Belmont, CA (US); Kevin Ching, Berkeley, CA (US); David Staas, Menlo Park, CA (US); Keith Kilpatrick, San Francisco, CA (US); Leonid Blyukher, Burlingame, CA (US); Veronica Milenkiy, Burlingame, CA (US)

(21) Appl. No.: 14/295,067

(22) Filed: Jun. 3, 2014

(51) Int. Cl. G06Q 30/02

(52) U.S. Cl. CPC G06Q 30/0246

(57) ABSTRACT

Measuring advertising effectiveness is disclosed. Attribute data included in a first user profile may be used to select a second user profile that is substantially similar to the first user profile. First behavior information may be determined based at least in part on an association between the first user profile and a location associated with an advertising content data. The first user profile may include an indication of exposure to the advertising content data and the second user profile does not. Second behavior information may be determined based at least in part on an association between the second user profile and the location. An advertising effectiveness value may be generated based at least in part on the first behavior information and the second behavior information.

### BACKGROUND OF THE INVENTION

Advertisers (e.g., marketers) often run advertising campaigns in which digital advertisements associated with a business (e.g., retail location, restaurant, etc.) are provided to device users (e.g., on a computer, mobile device, etc.). Often a goal of these campaigns is to increase the number of visitors to a location associated with the business. To assess the effectiveness of a digital advertising investment, advertisers typically monitor location visits and/or sales increases. For example, a retailer may count the number of people who visit a retail location and/or purchase products at the retail location after the digital advertisement has been served. Using these approaches, it may be difficult for advertisers to determine whether an increase in location visits and/or sales results from the digital advertising campaign or other factors. As a result, the influence of an advertisement campaign on foot traffic to a location is typically difficult to quantify and is often over- or under-stated.

### BRIEF DESCRIPTION OF THE DRAWINGS

Various embodiments of the invention are disclosed in the following detailed description and the accompanying drawings.

FIG. 1 is a flow chart illustrating an embodiment of a process to measure advertising effectiveness.

FIG. 2 is a block diagram illustrating an embodiment of a system to generate advertising effectiveness values.

FIG. 3 is a diagram illustrating an embodiment of a technique to measure advertising effectiveness.

FIG. 4 is flow chart illustrating an embodiment of a process to select a test/exposed user profile.

FIG. 5 is a flow chart illustrating an embodiment of a process to select a user profile.

FIG. 6 is a flow chart illustrating an embodiment of a process to select control group user profiles.

FIG. 7 is a diagram illustrating an embodiment of a process of calculating behavior information.

FIG. 8 is a graphic illustrating an embodiment of example advertising effectiveness measurement result.

FIG. 9 is a flow chart illustrating an embodiment of a process to generate advertising effectiveness values.

FIG. 10 is a flow chart illustrating an embodiment of a process to provide digital advertisements.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Measuring advertising effectiveness is disclosed. In various embodiments, attribute data included in a first user profile may be used to select a second user profile that is substantially similar to the first user profile. The first user profile may include an indication of exposure to advertising content data associated with a location and the second profile may not include such an indication. For example, a first user profile may be associated with a first user that has seen an advertisement for a location and the second user profile may be associated with a second user who has not seen the ad. In various embodiments, propensity score matching and/or other approaches may be used to select a second user profile. For example, a propensity score may be generated based on the attribute data in the first user profile (e.g. demographic data, behavioral data, etc.) and the propensity score may be compared to propensity scores generated for other user profiles to select a second user profile. The second user profile may, for example, be associated with a propensity score that matches (e.g., most closely matches) the propensity score associated with the first user profile.

According to some embodiments, first behavior information (e.g., a change in number/frequency of visits to a location over a period prior to and over a period after seeing an ad related to the location) may be determined based at least in part on an association between the first user profile and a location associated with the advertising content data. Second behavior information may be determined based at least in part on an association between the second user profile and the location. An advertising effectiveness value may be generated based at least in part on the first behavior information and the second behavior information.

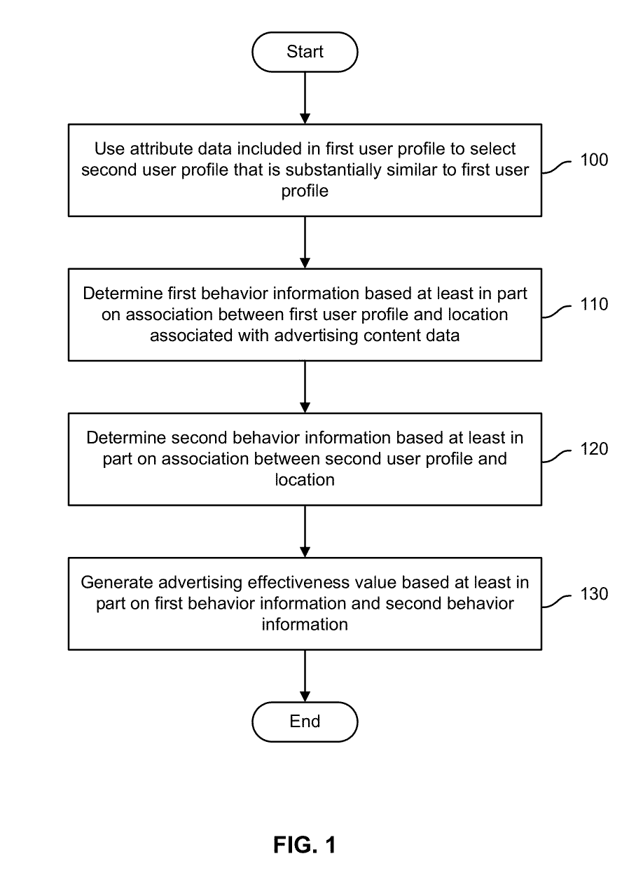

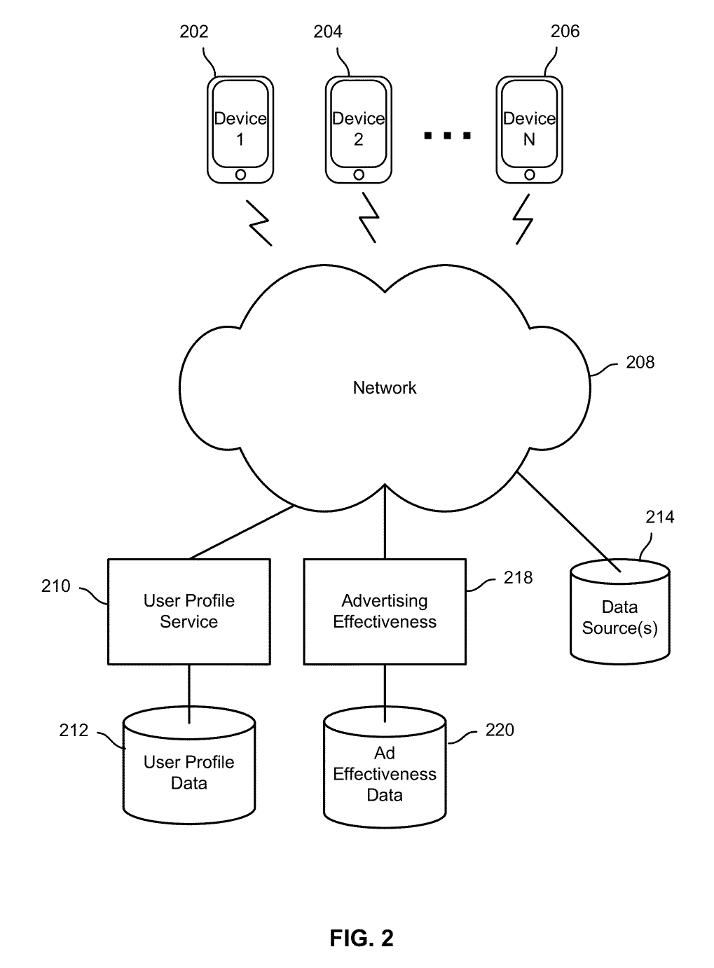

FIG. 1 is a flow chart illustrating an embodiment of a process to measure advertising effectiveness. In various embodiments, the process may be performed by the advertising effectiveness platform 218 of FIG. 2 (discussed below). At 100, attribute data included in a first user profile may be used to select a second user profile that is substantially similar to the first user profile. In various embodiments, attribute data may include, for example, demographic data, behavioral data, data from third-party sources, psychographic data, location visit frequency patterns, shopping cart spend data (e.g., including similar products and/or categories of products), and/or any other data associated with a user. A first user profile may include a user profile for a user that has been exposed to advertising content associated with a location (e.g., an advertisement to drive foot traffic to the location). In some embodiments, attribute data included in a first user profile may be compared to attribute data associated with one or more other user profiles associated with users who have not been exposed to the advertising content. And a user profile including attributes that are substantially similar to (e.g., matches) the attributes included in the first user profile may be selected. Various approaches may be used to identify (e.g., select) matching user profiles including, for example, propensity score matching, statistical matching approaches, one-to-one matching, and/or any other any other matching technique.

In various embodiments, the first user profile may include a user profile from an exposed/test group, and the second user profile may include a user profile from a control group and/or general population group. The first user profile and second user profile may be used to test (e.g., measure) the effectiveness and/or influence of advertising content data associated with a location (e.g., an advertisement to drive users to a retail location). The first user profile (e.g., the exposed/test group user profile) may include an indication that a user associated with the first user profile has been exposed to advertising content data associated with a location. And the second user profile (e.g., control group user profile, general population user profile) may include an indication that a user associated with the second user profile has not been exposed to the advertising content. In various embodiments, to accurately measure the influence of the advertising content data, the second user profile may be selected such that any attributes, characteristics, biases, confounding variables, and/or other factors that may affect the outcome of the measurement are reduced and/or eliminated. In certain cases, any variables potentially affecting the outcome of the measurement may be reduced by selecting a second user profile that is substantially similar (e.g., as close as possible) to the first user profile.

By way of example, a first user profile may include attribute data including demographic data (e.g., data indicating that the user is female, 30-40 years old, resides in San Francisco, Calif., has a household income of $100,000, etc.), behavioral data (e.g., the user visits a coffee shop three times per week), third party data (e.g., purchased a condo for $200,000 in 2006), psychographic data (e.g., leads a healthy lifestyle, likely to vote for a particular political party, etc.), and other attribute data. Based on the attribute data, a second user profile that matches (e.g., is substantially similar to) the first user profile may be selected. The second user profile may include similar (e.g., matching) attribute data including demographic data (e.g., user is female, 30-40 years old, residing in San Francisco, Calif., household income of $95,000, etc.), behavioral data (e.g., visits the coffee shop four times per week), and/or other attribute data.

In one example matching approach, the attribute data from user profiles may be used in a regression approach (e.g., logistic regression, linear regression, etc.) to generate a model (e.g., generalized linear model (GLM), logit model, discreet choice model, etc.). For example, a model (e.g., generalized linear model (GLM)) may represent a correlation between a dependent variable of whether or not a user has been exposed to advertising content and a set/vector of covariates including attribute data included in the user profiles. The model (e.g., generalized linear model (GLM)) may be used to generate propensity scores for each of the multiple profiles. In some embodiments, a propensity score associated with the first user profile (e.g., associated with a user who has seen an ad) may be used to identify/select a matching (e.g., most closely matching) second user profile (e.g., associated with a user who has not seen the ad). A variety of matching approaches including nearest neighbor, kernel, local linear, caliper, and/or other matching techniques may be used to match the first and second user profiles based, for example, on propensity scores.

At 110, first behavior information may be determined based at least in part on an association between the first user profile and a location associated with advertising content data. In various embodiments, behavior information may include information associated with a user's presence at one or more locations. In some embodiments, a first behavior information may include a number of instances, a number of instances over a period of time, and/or a frequency/rate that a user associated with the first user profile has been determined to be present at the location (e.g., visited the location). For example, a user may be determined to be present at a location based on location data (e.g., latitude/longitude and/or other location identifying information) received from a mobile device associated with the user. In certain cases, the location data may be received in connection with an advertisement request, a WiFi login page, marketing opportunity within a mobile application, entering a geo-fence, a deal and/or opportunity associated with a mobile device, etc. In various embodiments, location data received from a user device may be mapped to one or more defined locations. And based on a mapping of location data to a location associated with advertising content data, a user may be determined to be present at that location. When a user is determined to be present at a location, a user profile associated with that user may be updated to include information (e.g., behavioral information) associated with the user's presence at the location. For example, the user profile may be updated to include the location, a time (e.g., time/day stamp) of presence, duration of presence (e.g., five minutes), and/or other information related to the user's presence at the location. This information may be used to determine behavior information associated with the user profile and the location.

According to various embodiments, behavior information may include a number of times that and/or frequency with which a user associated with a user profile has been present at a location prior to and/or after being exposed to a digital advertisement. For example, a user associated with a first user profile may receive a digital advertisement including advertising content data associated with a location at certain time (e.g., a time (t₀), a date, etc.). The time at which a user is exposed to advertising content data may include an advertising exposure time (e.g., time of exposure). In various embodiments, a user may have been exposed to advertising content data multiple times and the advertising exposure time may include the time of first exposure, time of last exposure, an average/median time over a period of multiple exposures, and/or any other time.

In some embodiments, behavior information associated with a first user profile may include a number of times a first user visited the location over a period of time (e.g., one week, three days, etc.) prior to exposure to advertising content data (e.g., viewing an ad). The period prior to exposure may include, for example, a look-back period. The look-back period may include any period of time (e.g., a predefined period, arbitrary period, etc.). A number, frequency, and/or rate at which a user visits a location during the look-back period may include a natural visit frequency/rate. A natural visit rate may represent a rate at which a user visits a location in the absence of exposure to advertising content (e.g., of the user's own volition, uninfluenced by advertising content, etc.).

In various embodiments, behavior information associated with the first user profile may include a number of times the user visited the location over a period of time after the time of exposure to the advertising content data (e.g., viewing the ad). The period of time after advertising exposure may include a look-forward period, and the look-forward period may be selected/determined in a manner similar to the look-back period. In certain cases, the look-forward period, however, may be selected to be substantially different than the look-back period. In another example, behavior information may include a frequency (e.g., one time per day, three times per week, etc.) at which the user visited the location during the look-forward period after exposure to the advertising content.

In some embodiments, behavior information may include a difference between a natural visit rate (e.g., a number of times and/or frequency at which a user was at the location during a period of time (e.g., a look-back period) prior to exposure to the advertising content data) and a number of times and/or frequency at which the user was at the location during a period of time after exposure (e.g., a look-forward period). The first behavior information may, for example, include value(s) quantifying an increase, decrease, and/or lack of change of the first user's behavior relative to the location (e.g., presence at the location) prior to and after seeing an advertisement. In various embodiments, an increase in presence at a location after viewing advertising content may indicate that the advertising content was successful in influencing the behavior of the user.

In various embodiments, behavior information may be determined based on location data from multiple mobile devices. For example, a user may be present at a location on a first day as determined by location information from a first device. After the first day, the user may replace the first device with a second device. Subsequently the user may be determined to be present at the location based on location data from the second device. In this case, location information received from both devices may be included in a user profile for the user, and behavior information may be determined based on location data from both devices that is included in the user profile.

At 120, second behavior information may be determined based at least in part on an association between the second user profile and the location. In various embodiments, the second behavior information may include a number of instances, a number of instances over a period of time, and/or a frequency that a user associated with the second user profile (e.g., a control group profile) has been determined to be present at the location (e.g., visited the location).

In various embodiments, the second behavior information may include a change, if any, between the second user's visit frequency over a period (e.g., a look-back period) prior to a point in time as compared with the second user's visit frequency over a period (e.g., a look-forward period) after the point in time. The point in time (e.g., a reference time) may include, for example, the time at which the first user was exposed to the advertising content, a time relative to the time at which the first user was exposed to the advertising content, an arbitrary time, a time selected to ensure a proper comparison with the first behavior information, and/or another time.

At 130, an advertising effectiveness value (e.g., a value representing advertising effectiveness, advertising effectiveness indicator) may be generated based at least in part on the first behavior information and the second behavior information. In some embodiments, an advertising effectiveness value may include number(s), value(s), percentage(s), metric(s) (e.g., a return on investment (ROI) metric, key performance indicator (KPI)), and/or any other data. The advertising effectiveness value may represent a change in number of visits (e.g., increase/lift in foot traffic) to a location as a result of exposure to the advertising content data.

In various embodiments, an advertising effectiveness value may be calculated/generated based on the first and second behavior information. In some embodiments, the advertising effectiveness value may be generated based on a comparison between a change in behavior from a time (e.g., a first time, a series of times, etc.) a first user sees an ad relative to their natural visit rate and a change in behavior of a second user who did not see the ad at the same time (e.g., an absolute same time, relative same time, etc.). Stated another way, the advertising effectiveness value may be generated based on a comparison of the first behavior information associated with a first user who saw an ad related to a location and second behavior information associated with a second user who did not see the ad. As discussed above, the first behavior information may include a change in a first user's visit behavior after exposure to advertising content relative to their natural visit rate. In other words, the first behavior information may be calculated based on a comparison (e.g., difference, change, etc.) of a first user's visit frequency to a location over a period of time (e.g., a look-back period) prior to exposure to advertising content related to the location and the user's visit frequency over a period after exposure (e.g., a look-forward period) to the advertising content. A second behavior information may include a change in behavior of a second user, who was not exposed to advertising content, as measured by a comparison of the second user's visit frequency to the location over a period (e.g., look-back period) prior to a certain time (e.g., the time when the first user saw the ad, a time relative to the time the first user saw the ad, an arbitrary time, etc.) and the second user's visit frequency over a period (e.g., look-forward period) after that time. The comparison of the first behavior information and second behavior information may be used to generate an incremental lift (e.g., advertising effectiveness value, which can be positive, negative, and/or zero)) associated with the advertising content.

By way of example, first behavior information may indicate that a first user visited a coffee shop four times in the two weeks (e.g., a look-back period) prior to exposure to an ad for the coffee shop (e.g., an ad for a free coffee at the shop displayed to the first user on their mobile device). This visit rate over the look-back period (four times in two weeks (i.e., two times per week)) may include a natural visit rate for the first user. The first behavior information may also indicate that the first user visited the coffee shop four times in the week following exposure to the advertisement (e.g., a look-forward period). A second user profile may be matched to the first user profile using the matching techniques discussed herein. The second user may be a user with similar attributes to the first user (e.g., a Doppelganger of the first user). Second behavior information may indicate that the second user visited the coffee shop three times over the two weeks (e.g., a look-back period) prior to a point in time (e.g., the time the first user was exposed to the ad, a reference time, etc.) and two times in the week after that point in time. The advertising effectiveness value may be calculated based on the first behavior information and second behavior information. In one example, the advertising effectiveness value may include a comparison between a change in the first user's visit frequency prior to and after ad exposure time (e.g., four visits per week during the look-forward period versus two visits per week during the look-back period or a change/increase of two visits per week) and a change in the second user's visit frequency prior to and after the point in time (e.g., two times per week during the look-forward period and 1.5 times per week during the look-back period or a change of 0.5 visits per week).

In various embodiments, the process of generating advertising effectiveness values may be repeated for multiple pairs of users (e.g., associated with a location). And the multiple advertising effectiveness values may be aggregated (e.g., summed up, added together) to generate an aggregate advertising effectiveness value as discussed in detail below. An aggregate advertising effectiveness value including one or more advertising effectiveness values may include a location conversion index (LCI). In various embodiments, a group of users may be selected to determine an effectiveness/influence of advertising content (e.g., in driving users to a retail location). The group of users may, for example, be related to the location in some way (e.g., each user may have visited the location over a period of time, the users may have similar demographic attributes, etc.). The group of users may be divided into subgroups including an exposed subgroup (e.g., test subgroup) of users that have been exposed to the advertising content data and control subgroup including users not exposed to the advertising content data. Using the techniques discussed herein user profiles from the exposed subgroup may be paired to user profiles from the control subgroup and/or a general population subgroup. And advertising effectiveness values may be generated for each pairing of users, and the advertising effectiveness values may be aggregated (e.g., summed up) to generate an aggregate advertising effectiveness value. In various embodiments, the process of generating advertising effectiveness values may be performed iteratively across many different user profiles.

In some embodiments, the process of generating advertising effectiveness values may be repeated for multiple types of advertising content. For example, advertising effectiveness values may be generated for multiple versions of advertising content data.

FIG. 2 is a block diagram illustrating an embodiment of a system to generate advertising effectiveness values. In the example shown, users use mobile and/or other devices, represented in FIG. 2 by devices 202, 204, and 206, to communicate via one or more networks, represented in FIG. 2 by network 208, e.g., a mobile telecommunications network and/or the Internet. A user profile service 210 (e.g., a user profile generation service, location graph-based service, etc.) residing on one or more servers receives location information associated with the respective users of devices such as devices 202, 204, and 206. For example, global position system (GPS) and/or other location information (e.g., WiFi hotspot id, Bluetooth Low Energy beacon, iBeacon, carrier mobile subscriber positioning data, IP address for a fixed location, etc.) may be received in connection with ad requests, e.g., from a mobile app being used by a user and/or a page visited using a browser software on a mobile device. The user profile service 210 uses information associated with the current and/or past locations at which the user has been located to determine attributes to be associated with the user. The attributes may be stored in a user profile for the user. User profiles may be stored in a user profile data store 212.

In various embodiments, a user profile may include, for example, demographic data (e.g., household income, residence, value of home(s), occupation, work location, age, gender), behavioral data, data from third party data sources 214 (e.g., property records, social network profile information, etc.), mobile device data (e.g., a list of applications on a device), psychographic data, location visit frequency patterns, shopping cart spend data (e.g., including similar products and/or categories of products), and/or any other data associated with a user.

In some embodiments, behavioral attributes may be derived, for example, from a user's past locations (e.g., location pattern(s)), prior actions, and/or other data. For example, a user (e.g., associated with user profile) may have been determined to be at a location based on a location data received, for example, along with a mobile advertising request (e.g., from the user's mobile device). The location data may be mapped to a business, place of interest, zip+4 code, and/or other location. The mapped location data may be used to update a location pattern in the user's profile. The location patterns, behavior attributes, and/or other location-related information may be included in a location graph in, for example, the user's profile.

In some embodiments, demographic, behavioral, and/or other attributes associated with the business, place of interest, etc. to which a user's location has been mapped may be included in a user profile associated with that user. For example, a business (e.g., location) may be associated with demographic, behavioral, and/or other attributes. And as a result of a user's detected presence at the business, behavioral and/or other attributes associated with the business may be attributed to the user (e.g., added to a user profile associated with the user). In certain cases, attributes added to a user profile may be confirmed to be correct or incorrect based on other information (e.g., attributes associated with other locations the same user has visited, information from third party data sources, a user's device, etc.).

In some embodiments, an advertising effectiveness platform/service 218 residing on one or more servers generates advertising effectiveness values (e.g., advertising effective index(es), location conversion index(es)/values, etc.) based on information derived from one or more user profiles. The advertising effectiveness service 218 may query, mine and/or otherwise process user profile information stored in the user profile data store 212. For example, user profile information may be selected from the user profile data store 212 and behavior information may be determined based on the selected user profile information. Advertising effectiveness values (e.g., generated based on the behavior information) may be stored in an advertising effectiveness data store 220. In various embodiments, an advertising provider may use the advertising effectiveness service 218 to measure the effectiveness (e.g., influence, value, ROI, etc.) of an advertising campaign.

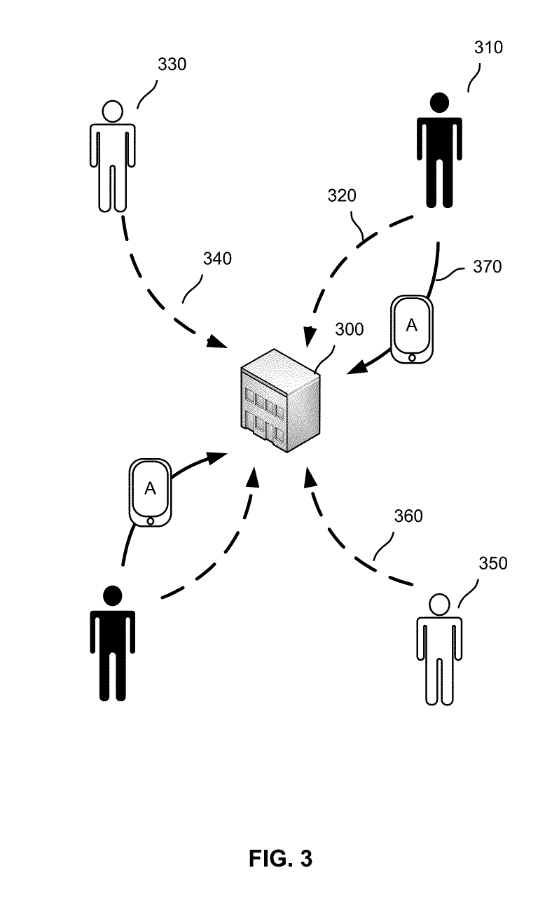

FIG. 3 is a diagram illustrating an embodiment of a technique to measure advertising effectiveness. In the example shown, an advertiser, advertisement provider, advertisement platform, and/or other entity may seek to determine an effectiveness of an advertising campaign associated with a retail location 300 (e.g., an advertisement associated with a retail location). A first user 310 may be selected based on a determination that the first user 310 has been served advertising content associated with the campaign, the first user 310 has visited (320) the location 300 prior to being served advertising content, and/or other criteria. In various embodiments, attribute data associated with a first user 310 (e.g., included in a first user profile) may be used to select a second user 330. For example, location attribute data associated with the first user 310 may indicate that the first user is a female, age 20-30, and employed at a technology firm. The location attribute data may also indicate that the first user 310 visited (320) the retail location 300 (e.g., a fashion retailer) four times in the month prior to viewing an advertisement for the retail location. This natural visit frequency (320) prior to being served the advertising content may include normal visits, unaided visits, and/or other types of visits to the retail location 300. Based on the first user's attribute data, a second user 330 may be selected. In various embodiments, the second user 330 may be selected using attribute-based matching, propensity score matching, and/or other matching approaches. The second user 330 may, for example, include a user most similar (e.g., in demographic, behavioral, and/or other attributes; propensity score; and/or other metrics) to the first user 310. The second user 330 may be selected based on a determination that the second user 330 has not been exposed to the advertising content associated with the retail location 300 and/or any advertising content associated with the retail location 300. In this example, a second user 330 who is a female, age 20-30, employed at a law firm and visits (340) the retail location 300 three times per month may be selected. Whereas, another user 350 who is a male, aged 40-50, employed as a doctor, and visits (360) the retail location 300 two times per quarter may not be selected as a similar user. The user 350 may, however, be selected as a randomly-selected user as discussed below.

In various embodiments, first behavior information may be determined. In certain cases, the first behavior information may represent a comparison of a number of visits prior to and after the first user has been exposed to the advertising content (e.g., has viewed an ad, is presumed to have viewed an) associated with the retail location 300. According to some embodiments, second behavior information may be determined. In certain cases, the second behavior information may represent a number of times the second user 370 visits the retail location 300 prior to and after a certain point in time (e.g., the time the first user was exposed to the advertising content, another time, etc.). In various embodiments, an advertising effectiveness value may be generated based on the first behavior information associated with the first user 310 and the second behavior information associated with second user 330. In various embodiments, the advertising effectiveness value may quantify/represent the influence of the advertising content data associated with the location 300.

According to some embodiments, an advertising effectiveness value may be generated based on a comparison of behavior information associated with the first user 310 and behavior information associated with a randomly-selected user 350 (e.g., a user from the general population). In various embodiments, a randomly-selected user 350 may be selected based on a determination that the user 350 is associated with the location 300 (e.g., has visited the location over a period of time). It may be determined, for example, that the user 350 has visited (360) the retail location 300; however, demographic data associated with user 350 may not be similar to the demographic data associated with the first user 310. In various embodiments, an advertising effectiveness value may be generated based the behavior information associated with the first user 310 and behavior information associated with the randomly-selected user 350 using the approaches discussed herein. Generating an advertising effectiveness value based on a comparison of the behavior information associated with the first user 310 and a randomly-selected user 350 may provide additional insight into the effectiveness/influence of an advertisement.

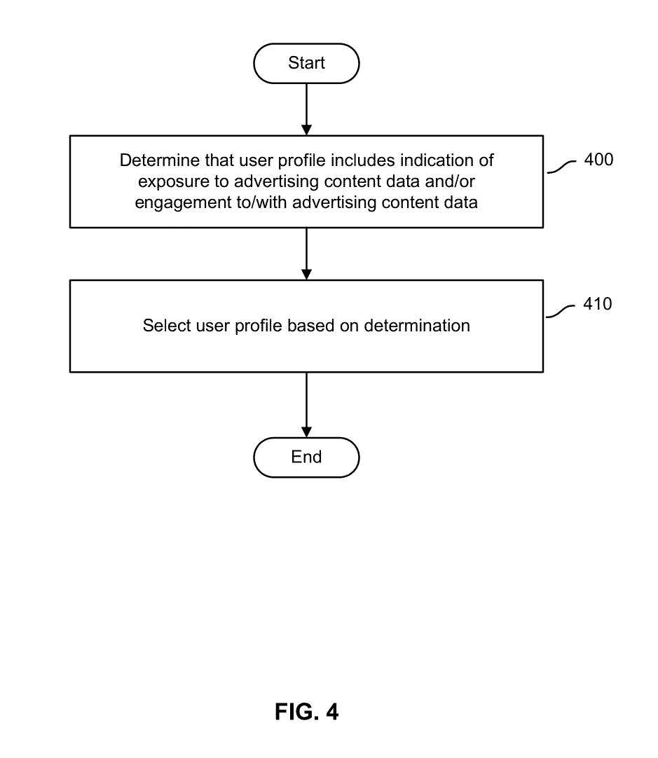

FIG. 4 is flow chart illustrating an embodiment of a process to select a test/exposed user profile. In various embodiments, the process is performed by advertising effectiveness platform 218 of FIG. 2. At 400, it may be determined that a user profile includes an indication of exposure to advertising content data and/or engagement to/with advertising content data. For example, an indication of exposure to advertising content data may include a record indicating that a digital advertisement including advertising content data associated with a location has been presented to a user. The indication may be generated, for example, when a digital advertisement is output to a user on a device (e.g., a mobile device, computer, smart television, wearable computer, etc.). An indication of engagement to/with advertising content data may include a record indicating that a user has engaged with advertising content by, for example, clicking on an ad, expanding an ad, engaging with an via voice input, and/or other records. In various embodiments, an indication of exposure/engagement may be associated with user profile and not a specific device. For example, a device (e.g., a home computer) on which the user was presented advertising content data and/or interacted with advertising content may be different than a device detected to be at a location of interest. In some embodiments, an indication of exposure/engagement may be generated when it is determined that a user has viewed and/or is likely to have viewed an advertisement presented in a non-digital medium (e.g., a print ad, mailed advertisement, etc.).

At 410, the user profile may be selected based on the determination that the user associated with the profile has been exposed/engaged (e.g., is presumed to have viewed) to and/or engaged with the advertising content data. In various embodiments, a first user profile (e.g., test user profile) may be selected as a test user profile (e.g., for comparison with a control user profile as discussed herein) based on the determination that the first user profile includes an indication of exposure/engagement to the advertising content data.

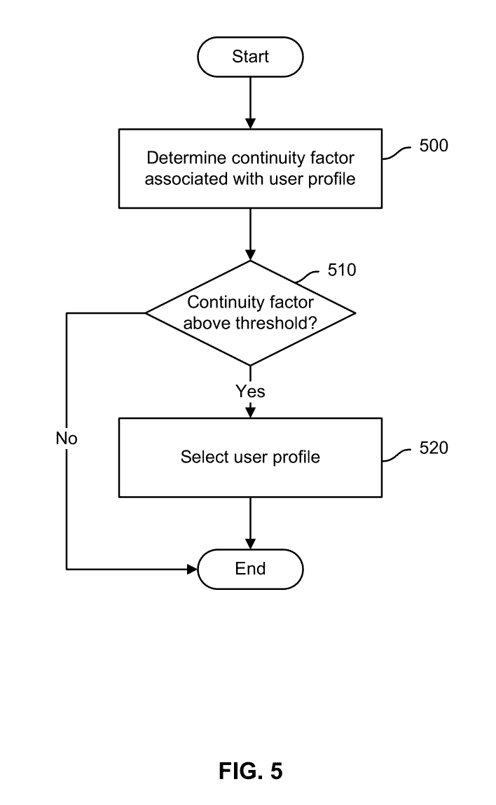

FIG. 5 is a flow chart illustrating an embodiment of a process to select a user profile. In various embodiments, the process is performed by advertising effectiveness platform 218 of FIG. 2. At 500, a continuity factor associated with a user profile may be determined. In various embodiments, continuity factors associated with user profiles may be used to select statistically significant user profiles. A continuity factor may indicate whether and/or to what extent a user was an active user (e.g., active in the system) prior to the time at which advertising content is served and/or after the advertising content has been served. A continuity factor, in some embodiments, may include a heart-beat indicator associated with the user. For example, if a user is determined to have been an active user on three separate days in the week prior to being served an advertisement for a location and three separate days after viewing the advertisement, the continuity factor for that user may be determined to be three. In various embodiments, the period of time prior to ad exposure and after ad exposure may be selected based on various factors associated with the advertising effectiveness calculation. The periods of time may, for example, be provided via user interface and/or other console from an advertiser.

In various embodiments, a continuity factor for a user profile may be generated based on location data from multiple mobile devices. For example, a user may be present at a location on a first day as determined by location information from a first device. After the first day the user may replace the first device with a second device. Subsequently the user may be determined to be present at the location based on location data from the second device. In this case, location information received from both devices may be included in a user profile for the user, and a continuity factor may be generated from the location data from both devices.

At 510, it may be determined whether a continuity factor is above a threshold. In various embodiments, a threshold continuity factor may be set to, for example, one or any other value. A continuity factor greater than or equal to a threshold (e.g., one) may indicate that a user has been an active user before and after being served advertising content. This may indicate that the user profile is viable to be used in the propensity score calculation. In this case the process may proceed to step 520. In some embodiments, a continuity factor below a threshold (e.g., one) may indicate that the user was not present in the system prior to being served the advertisement. A user profile associated with a continuity factor below a threshold (e.g., one) may not be viable to be used in the propensity score calculation for purposes of evaluating the influence/effectiveness of advertising content data. In this case, the user may not be selected and the process may end.

At 520, a user profile associated with a continuity factor above a threshold may be selected. In various embodiments, a user profile associated with a continuity factor value above a threshold may be selected as a test user profile (e.g., first user profile).

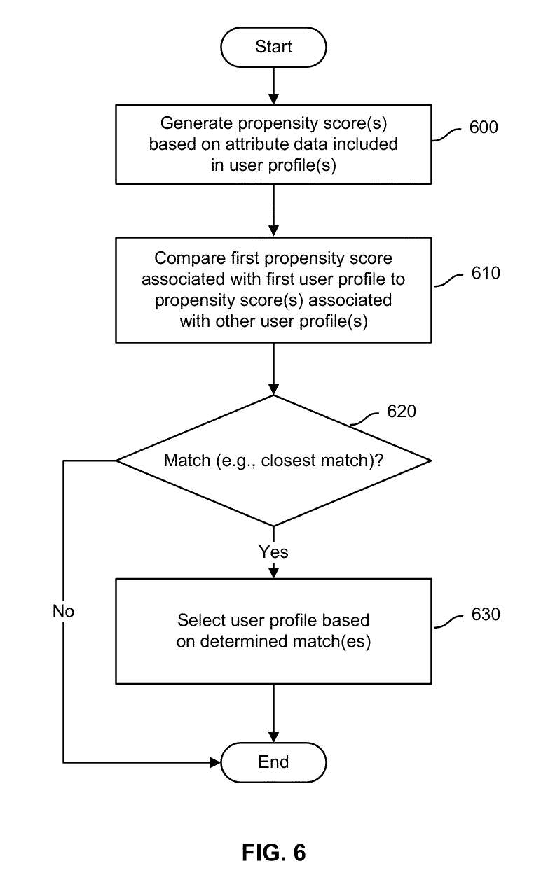

FIG. 6 is a flow chart illustrating an embodiment of a process to select control group user profiles. In various embodiments, the process is performed by advertising effectiveness platform 218 of FIG. 2. At 600, propensity scores may be generated based on attribute data included in one or more user profiles. In some embodiments, a propensity score may represent a conditional probability of assignment to a particular treatment (e.g., exposure to the advertising content) given a set (e.g., vector) of observed covariates (e.g., attribute data including, for example, demographic attributes, behavioral attributes, psychographic data, etc.). For example, a propensity score may represent a conditional probability of exposure to advertising content given a vector of attribute data (e.g., demographic data, behavioral data, psychographic data, location visit frequency patterns, shopping cart spend data (e.g., including similar products and/or categories of products)).

In various embodiments, a propensity score associated with a user profile may be calculated by regressing the variable of whether or not the user has been exposed to advertising content against the attribute data included in the user profile. Using regression and/or other statistical approaches a model (e.g., generalized linear model (GLM), discreet choice model, etc.) may be generated representing a correlation between a dependent variable of whether or not a user has been exposed to advertising content and a set/vector of covariates including attribute data in the user profiles. In various embodiments, attribute data may be selected for inclusion in the set/vector of covariates to adjust for natural visit patterns, seasonal visit patterns, events, and/or other factors associated with the location of interest. The model (e.g., generalized linear model (GLM)) may be used to generate propensity scores for each of the multiple profiles. In some embodiments, the propensity score calculation process may account/compensate for natural visit patterns, seasonal visit patterns, events, and/or other factors associated with the location by virtue of the attribute data included in the propensity score calculation. For example, matching user profiles based on propensity score may reduce bias resulting natural visit patterns, seasonal visit patterns, events, and/or other factors.

At 610, a first propensity score associated with the first user profile (e.g., a user profile in an exposed group) may be compared to one or more propensity scores each associated with a user profile in a control group (e.g., a group of user profiles for users not exposed to the ad content). In various embodiments, a first propensity score associated with the first user profile (e.g., a test group user profile) may be compared to one or more propensity scores to determine matching (e.g., closest/best matching) propensity scores.

At 620, it may be determined whether a first propensity score matches one or more propensity scores. In some embodiments, a first propensity score may be compared to one or more propensity scores to determine a most-closely matching propensity score. In certain embodiments, nearest neighbor, kernel, local linear, caliper, and/or other matching techniques may be used to match the first propensity score to one or more propensity scores. In various embodiments, the first propensity score may be iteratively compared to multiple propensity scores to identify a most-closely matching propensity score. For example, a first propensity score (e.g., associated with a first user profile) may include a scalar value of 0.7, and this score may be compared to multiple propensity scores (e.g., 0.72, 0.65, 0.6, etc.) each associated with a user profile. Based on this example comparison, the propensity score of 0.72 may be selected as a most closely matching propensity score, and the process may proceed to step 630. In the event no propensity score is determined to match the first propensity score, the process may end.

In some embodiments, propensity scores may be matched based on a threshold and/or limit. For example, a first propensity score may match a second propensity score if the difference between the two propensity scores is within a threshold. For example, a first propensity score associated with a first user profile may include a scalar value of 0.35 and a second propensity score may include a scalar value of 0.3 and a threshold difference may be defined as 0.1. Because this difference between the first propensity score (e.g., 0.35) and second propensity score (e.g., 0.3) is less than the threshold (e.g., 0.1), the second propensity score may be determined to match (e.g., potentially match) the first propensity score.

At 630, user profiles may be selected based on the matching propensity scores. In various embodiments, based on the propensity score matching process, the first user profile (e.g., including an indication of exposure to the advertising content) may be matched to a second user profile, and this pair of profiles may selected. Once selected, an advertising effectiveness value may be calculated for the pair of user profiles.

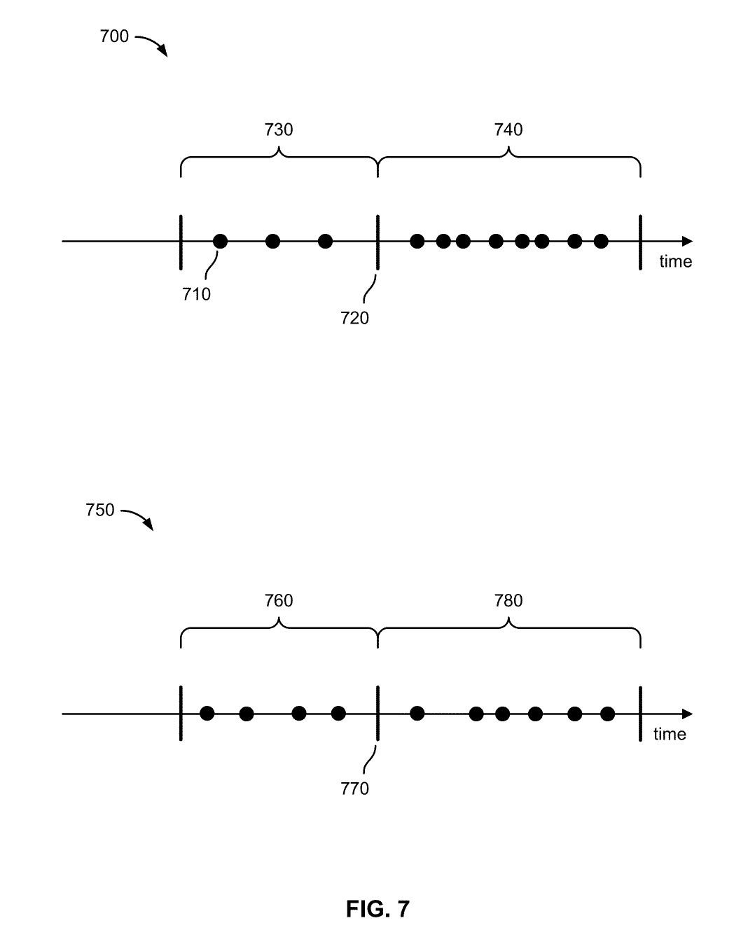

FIG. 7 is a diagram illustrating an embodiment of a process of calculating behavior information. In the example shown, a first timeline 700 depicts a first user's behavioral patterns relative to a location (e.g., a retail location, restaurant, etc.) over a period of time. Each observation of the user 710 (e.g., point) on the timeline 700 may represent a point in time at which the first user was observed at the location. As depicted in the first timeline 700, the first user may, for example, have been served advertising content (e.g., associated with the location) at an ad exposure time 720 (e.g., time of ad exposure, t₀, etc.). In some embodiments, a look-back period 730 may include a period prior to the ad exposure time 720. A look-forward period 740 may include a period after the ad exposure time 720. In some embodiments, the look-forward period 740 and look-back period 730 may include equal or different lengths/durations of time.

In some embodiments, first behavior information (e.g., associated with a user profile) may include a comparison of a first user's natural visit rate and post-advertising exposure visit rate (e.g., after exposure to the advertising content) to the location. A natural visit rate may include a number/frequency of user visits to the location over the look-back period 730. A post-exposure visit rate may include a number/frequency of visits to the location over the look-forward period 740 after exposure to the advertising content. The first behavior information may include a difference (if any) between the first user's post-exposure visit rate and the natural visit rate.

In various embodiments, a second timeline 750 is shown depicting a second user's behavioral patterns relative to a same location over a period of time. The second user in this case may not have been exposed to advertising content related to the location. In some embodiments, a look-back period 760 for the second user may include a period prior to a point in time 770 (e.g., a reference time). A look-forward period 780 may include a period after the point in time 770. In various embodiments, the point in time 770 (e.g., reference time) may be equivalent to the advertising exposure time 720 (e.g., the same absolute time) at which the first user was exposed to the advertising content, another time determined based on the first and/or second user profile attributes, an arbitrary time, and/or any other time.

In some embodiments, the look-back period 760 associated with the second user may be related to the look-back period 730 associated with the first user. In one example, the two periods may span equivalent period(s) of time, though not necessarily the exact same period(s). For example, the first look-back period 730 may include a first week (e.g., the last Wednesday in December to the first Wednesday in January, etc.), and the second look-back period 760 may include (e.g., the first Saturday in February to the second Saturday in February). In another example, the first look-back period 730 and second look-back period 760 may span periods of time of varying duration. In various embodiments, similar relations may be exist between the first look-forward period 740 and second look-forward period 780.

In various embodiments, the look-back period 730, look-back period 760, look-forward period 740, look-forward period 780 may be determined/selected based on input from a user of the advertising effectiveness platform, attributes associated with the first/second user profiles, and/or other parameters. In some embodiments, the look-back periods 730, 760 and/or look-forward periods 740, 780 may be selected to account/adjust for natural visit patterns, seasonal visit patterns, events (e.g., weather events, a sale at the location, etc.) associated with the location, and/or other factors that may influence/affect/skew the calculation of the advertising effectiveness value.

By way of example with reference to the first user timeline 700, a first user may be observed (e.g., via a mobile device) at a restaurant three times during the look-back period 730 (e.g., as indicated by the three points 710 on the timeline during the look-back period 730). The look-back period 730 may include a one-week period prior to an ad exposure time of Jan. 1, 2014. The first user may have been shown advertising content related to the restaurant at the advertising exposure time (e.g., Jan. 1, 2014). And during the look-forward period 740 including the two-week period after Jan. 1, 2014, the first user may be observed at the restaurant eight times. In this case, the first behavior information may include a difference between the first user's frequency of visits to the location during the look-back period—three times per week—and the first user's visit frequency during the look-forward period—four times per week. The first behavior information may include, for example, an increase of one visit per week, a 33.3% increase in visits per week, etc.

As depicted, for example, in the second user timeline 750, a second user may be observed at the restaurant (e.g., the same restaurant) four times during a second look-back period 760—the one-week period prior to Feb. 1, 2014. The second user may also be observed at the restaurant five times during a second look-forward period 780—the two weeks after Feb. 1, 2014. In this case, the second behavior information may include a difference between the second user's visit frequency to the location during the first look-back period 760—four visits per week—and the second user's visit frequency to the location during the second look-forward period 780—six visits over two weeks. The second behavior information may include, for example, a decrease of one visit of per week, a 25% decrease in visits per week, etc. In this case, the change in visit behavior after the reference time 770 is negative (e.g., indicating a decrease). In certain cases, this negative value may be assumed to be the result from random behavioral patterns of the second user, and may be changed to zero indicating no change in behavior.

According to some embodiments, an advertising effectiveness value may be calculated based on the first behavior information and second behavior information. In this case the advertising effectiveness value may include a comparison between the first behavior information—an increase in one visit per week by the first user—and the second behavior information—a decrease of one visit per week by the second user. In this case, the advertising effectiveness value may include and incremental difference (e.g., incremental lift) of two visits per week. This value may indicate that exposure/interaction with the advertising content resulted in an increase visit frequency of two visits per week.

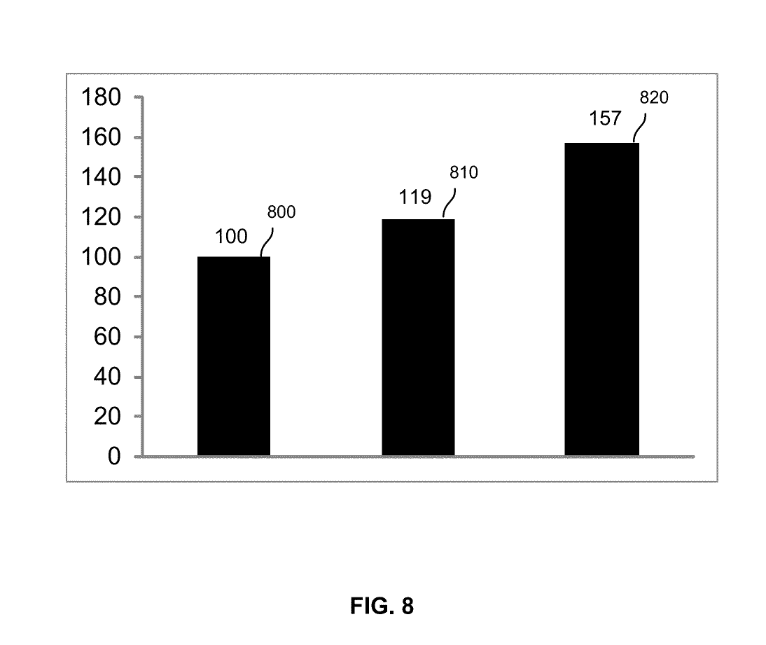

FIG. 8 is a graphic illustrating an embodiment of example advertising effectiveness measurement result. In the example shown, a first data set 800 may indicate a number of visits to a location (e.g., a retail clothing location) across a randomly-selected population of users. For example, the first data set 800 may represent a number of visits to a retail location by a group of randomly-selected users across a wide range of demographic, behavioral, and/or other attributes. A value associated with first data set (e.g., 100) may be a scaled and/or normalized value representing a number of visits (e.g., baseline number of visits) to a retail location.

In various embodiments, a second data set 810 may represent a number of visits to a location by a group of user profiles similar (e.g., substantially similar) to a group of test user profiles. For example, if a test user profile includes casual female clothing shoppers who have been exposed to the advertising content data, the second data set 810 may represent a number of visits to the retail location by user's associated with similar attributes (e.g., casual female clothing shoppers who have not seen the advertising content). In the example shown, a control group of user profiles identified as casual female clothing shoppers visited the retail location 19% more (e.g., over a period of time) than the general population.

In various embodiments, a third data set 820 may represent a number of visits to a location by users who were exposed to the advertising content associated with the location. For example, the third data set 820 may represent a number of visits to the retail location by test group users that were exposed to the advertising content data. In the example shown, a group of test user profiles (e.g., casual female clothing shoppers who viewed the advertising content data) visited the retail location 32% more than the matched control group (e.g., casual female clothing shoppers who did not view the advertising content data). The 32% increase may be equivalent to the amount of exposed group visits (157) relative to (e.g., divided by) the control group visits (119) or 1.32 for a 32% increase. The group of test user profiles may have visited the retail location 57% more than the randomly-selected general population. In various embodiments, the 32% increase in visits over the similar control group may include an advertising effectiveness value of 32%, 0.32, and/or another value. The 57% increase in number of visits over randomly-selected users may include an advertising effectiveness value of 57%, 0.57, and/or another value.

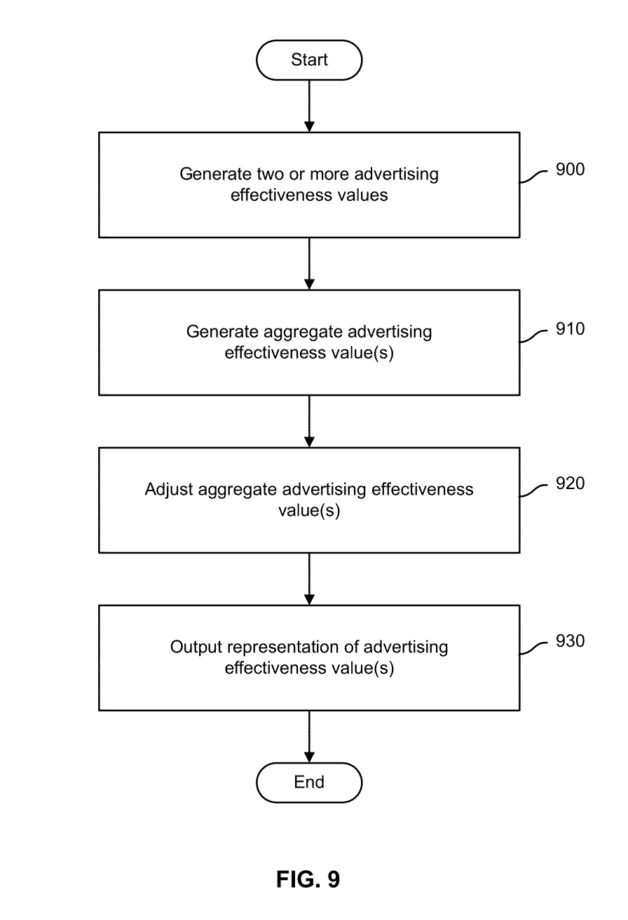

FIG. 9 is a flow chart illustrating an embodiment of a process to generate advertising effectiveness values. In various embodiments, the process is performed by advertising effectiveness platform 218 of FIG. 2. At 900, two or more advertising effectiveness values may be generated. In various embodiments, a group of users including similar attributes may be selected to determine an effectiveness/influence of advertising content (e.g., in driving users to a retail location). For example, an advertiser associated with a quick service restaurant (QSR) chain may seek to quantify the value of an adverting campaign in driving foot traffic a QSR location. A group of user profiles identified as regular QSR patrons (e.g., known to visit the QSR location twice per week) may be selected. Within this group an exposed subgroup (e.g., exposed audience) of user profiles that include an indication of exposure to the advertising content may be identified. And a non-exposed subgroup of user profiles may be identified. Advertising effectiveness values may be generated using the techniques discussed herein. For example, user profiles from the exposed subgroup may be paired to similar user profiles from the non-exposed group, behavior information may be determined (e.g., numbers/frequencies of visits to the QSR location before and/or after advertisement exposure), and advertising effectiveness values may be generated based on the behavior information.

At 910, aggregate effectiveness value(s) may be generated. In various embodiments, multiple advertising effectiveness values may be summed, aggregated, added together and/or otherwise combined to generate an aggregate advertising effectiveness value (e.g., a location conversion index). In various embodiments, an aggregate effectiveness value may include an advertising effectiveness value that has been updated based on other advertising effectiveness values. For example, two advertising effectiveness values may be merged/combined to generate a single advertising effectiveness value.

In various embodiments, advertising effectiveness values associated with any number of user profiles may be aggregated to generate the aggregate advertising effectiveness value. An aggregate advertising effectiveness value may represent an increase, decrease, and/or lack of change in a number of visits to retail location as a result of advertising content served to a defined group of users over a period of time. Continuing with the above example, the advertising effectiveness values generated based on the comparisons of the user profiles in the exposed subgroup and the users in the non-exposed subgroup of regular QSR patrons may be aggregated. For example, advertising effectiveness values may be generated for each user in the exposed subgroup and these values may be aggregated to generate an aggregate advertising effectiveness value across the group of regular QSR patrons. In one example, the aggregate advertising effectiveness value may, for example, indicate that the advertising campaign resulted in an increase of two visits per week per user who received the advertisement. In another example, the aggregate advertising effectiveness value may indicate a 25% increase in foot traffic to the QSR location over a defined period of time (e.g., one week before ad exposure compared to one week after ad exposure).

In various embodiments, advertising effectiveness values generated based on a comparison of user profiles exposed to advertising content and randomly-selected user profiles (e.g., not exposed to the ad content) may be included in an aggregate effectiveness value. For example, advertising effectiveness values may be generated based on comparisons of user profiles included in the exposed subgroup of male frequent QSR patrons to randomly-selected user profiles (e.g., not necessarily male frequent QSR patrons). These advertising effectiveness values may be added to an aggregate advertising effectiveness value, but may, for example, be given less weight in the aggregation.

At 920, an aggregate advertising effectiveness value may be adjusted. In various embodiments, an aggregate advertising effectiveness value may be scaled, normalized, and/or otherwise adjusted. For example, advertising effectiveness value(s) may be scaled to a value within a range of values (e.g., 0 to 100), percentage(s), and/or other value(s).

In various embodiments, advertising effectiveness values may include adjustments for natural visit patterns, seasonal visit patterns, events, and/or other factors as a result of the matching processes (e.g., propensity score matching), look-back period determinations, look-forward period determinations, and/or other processes discussed herein. In some embodiments, however, an aggregate advertising effectiveness value (e.g., generated based on one or more advertising effectiveness values) may be adjusted (e.g., post-calculation) to account for natural visit patterns, seasonal visit patterns, events (e.g., current events, weather, etc.), and/or other factors affecting visit rates to a location. For example, an aggregate advertising effectiveness value reflecting ad campaign-driven visits to a retail location may be reduced to account for an increase in natural visits over the holiday season.

At 930, a representation of the aggregate advertising effectiveness value may be output. In various embodiments, aggregate effectiveness values may be output (e.g., displayed to a user, provided to another node) in graphical form (e.g., as shown in FIG. 8), as a number, percentage, and/or any other representation.

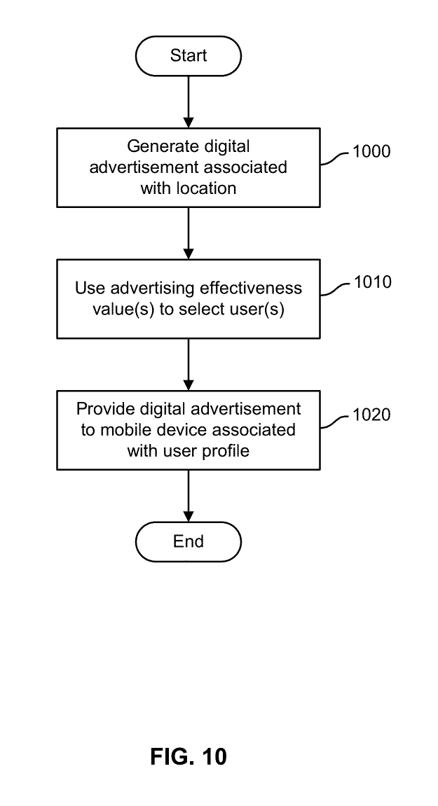

FIG. 10 is a flow chart illustrating an embodiment of a process to provide digital advertisements. At 1000, a digital advertisement associated with a location may be generated. In various embodiments, a digital advertisement may include a coupon, a banner advertisement, a pop-up advertisement, embedded advertisement, and/or other promotional content associated with a location (e.g., aimed at driving foot traffic to the location). For example, a digital advertisement may include a coupon for a 20% discount on the purchase of a cup of coffee at a coffee shop.

At 1010, advertising effectiveness value(s) may be used to select users to receive the digital advertisement. In various embodiments, advertising effectiveness values may be used to select a type of user that would be most receptive to (e.g., most likely influenced by) the digital advertisement. Continuing with the example, an advertising effectiveness value may have been previously generated indicating that a coupon for a free muffin at the coffee shop resulted in an increased visit frequency of one visit per month among males, between 20-30 years old, with a median salary of $50,000 per year. Another advertising effectiveness value may have been generated indicating that a coupon for a 15% discount on purchase of coffee resulted in an increased visit frequency of two visits per week among males, between 40-50 years old, who regularly attend sporting events. Based on these advertising effectiveness values, user profiles associated with males, between 40-50 years, who are likely to attend sporting events may be selected to receive the digital advertisement.

At 1020, a digital advertisement may be provided to mobile device(s) associated with the selected user profiles. In various embodiments, providing digital advertisement to users in a group known to respond favorably to similar advertisement content may increase the return on investment of a mobile advertising campaign.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
selecting, by a computing device and based on similarity in attribute data with a first user profile of a first user, a second user profile of a second user;
determining, by the computing device, a first behavior information of the first user in visiting a location associated with an advertising content data, wherein the first user profile includes an indication of exposure of the first user to the advertising content data;
determining, by the computing device, a second behavior information of the second user in visiting the location, wherein the second profile does not include an indication of exposure of the second user to the advertising content data; and
generating, by the computing device, an advertising effectiveness value based at least in part on the first behavior information of the first user and the second behavior information of the second user.

2. The method of claim 1, further comprising:
determining that a first propensity score associated with the first user profile matches a second propensity score associated with the second user profile; and
selecting the second user profile based at least in part on the determination.

3. The method of claim 2, further comprising:
generating the first propensity score based at least in part on the attribute data included in the first user profile; and
generating the second propensity score based at least in part on attribute data included in the second user profile.

4. The method of claim 1, further comprising:
determining that the first user profile includes an indication of exposure to the digital advertisement; and
selecting the first user profile based at least in part on the determination that the first user profile includes the indication.

5. The method of claim 1, further comprising:
generating a continuity factor based on a number of days, times or frequency at which a first user associated with the first user profile was active in the system prior to an exposure time associated with the advertising content data and a number of days, times or frequency at which the first user was active in the system after the exposure time; and
selecting the first user profile based at least in part on the continuity factor.

6. The method of claim 1, further comprising selecting the second user profile based at least in part on a continuity factor generated based at least in part on attribute data included in the second user profile.

7. The method of claim 1, wherein using the attribute data included in the first user profile to select the second user profile includes:
determining that the second user profile does not include an indication of exposure to the digital advertisement; and
selecting the second user profile based at least in part on the determination the second user profile does not include the indication of exposure.

8. The method of claim 1, wherein the attribute data includes one or more of behavioral data, demographic data, a location pattern, psychographic data, and third-party data.

9. The method of claim 1, further comprising:
generating an aggregate advertising effectiveness value based at least in part on a percentage difference of two or more advertising effectiveness values.

10. The method of claim 9, wherein the aggregate advertising effectiveness value includes a location conversion index.

11. The method of claim 1, wherein:
the first behavior information includes a number of times or frequency that a first user has been determined to be present at the location during one or more periods of time; and
the second behavior information includes a number of times a second user has been determined to be present at the location during one or more periods of time.

12. The method of claim 1, wherein:
the first behavior information includes a comparison between a frequency at which a first user associated with the first user profile has been determined to be present at a location during a period of time prior to a time of exposure to the advertising content data and a frequency at which the first user has been determined to be present at the location during a period of time after the time of exposure; and
the second behavior information includes a comparison between a frequency at which a second user associated with the second user profile has been determined to be present at the location during a period of time prior to a point in time and a frequency at which the second user has been determined to be present at the location during a period of time after the point in time.

13. The method of claim 12, wherein generating an advertising effectiveness value comprises:
generating the advertising effectiveness value based at least in part on a comparison of the first behavior information and the second behavior information.

14. The method of claim 12, wherein the point in time is related to the time of exposure to the advertising content data.

15. The method of claim 1, further comprising
generating a digital advertisement associated with the location;
using the advertising effectiveness value to select a user profile; and
providing the digital advertisement to a mobile device associated with the user profile.

16. A computing system, comprising:
a processor; and
a memory coupled with the processor, wherein the memory stores instructions configured to instruct the processor to:
select, by the computing system and based on similarity in attribute data with a first user profile of a first user, a second user profile of a second user;
determine, by the computing device, a first behavior information of the first user in visiting a location associated with an advertising content data, wherein the first user profile includes an indication of exposure of the first user to the advertising content data;
determine, by the computing system, a second behavior information of the second user in visiting the location, wherein the second profile does not include an indication of exposure of the second user to the advertising content data; and
generate, by the computing system, an advertising effectiveness value based at least in part on the first behavior information of the first user and the second behavior information of the second user.

17. The system recited in claim 16, wherein the memory is further configured to provide the processor with instructions which when executed cause the processor to:
determine that a first propensity score associated with the first user profile matches a second propensity score associated with the second user profile; and
select the second user profile based at least in part on the determination.

18. The system recited in claim 17, wherein the memory is further configured to provide the processor with instructions which when executed cause the processor to:
generate the first propensity score based at least in part on the attribute data included in the first user profile; and
generate the second propensity score based at least in part on attribute data included in the second user profile.

19. A non-transitory computer readable storage medium storing instructions configured to instruct a computer device to perform a method, the method comprising:
selecting, by the computing device and based on similarity in attribute data with a first user profile of a first user, a second user profile of a second user;
determining, by the computing device, a first behavior information of the first user in visiting a location associated with an advertising content data, wherein the first user profile includes an indication of exposure of the first user to the advertising content data;
determining, by the computing device, a second behavior information of the second user in visiting and the location, wherein the second profile does not include an indication of exposure of the second user to the advertising content data; and
comparing, by the computing device, the first behavior information of the first user and the second behavior information of the second user to measure effectiveness of the advertising content data.

20. The computer readable storage medium recited in claim 19, further the method further comprising:
determining that a first propensity score associated with the first user profile matches a second propensity score associated with the second user profile; and
selecting the second user profile based at least in part on the determination.
